(19) United States
(12) Patent Application Publication
(10) Pub. No.: US 2005/0145213 A1
(43) Pub. Date: Jul. 7, 2005

(54) Electric power generator assembly

(76) Inventor: Boris Schapiro, Berlin (DE)

Correspondence Address: Law Offices;Silber & Fridman, Suite 207, 1037 Route 46 East, Clifton, NJ, 07013, US

(21) Appl. No.: 11/072,481

(22) Filed: Mar. 4, 2005

Related U.S. Application Data
(63) Continuation of application No. PCT/EP03/09317, filed on Aug. 22, 2003.

(30) Foreign Application Priority Data
Sep. 6, 2002 (DE) 102 418 07.1

(51) Int. Cl. F02B 53/04; F01C 1/02

(52) U.S. Cl. 123/242; 123/205; 123/228; 418/61.3; 418/54

(57) ABSTRACT

An electric power generator assembly comprises a rotary piston engine having a housing, which defines a chamber. A rotary piston having an oval contour is rotatably guided in this chamber. A variable volume working chambers are defined between the wall of the chamber and the rotary piston. The rotary piston, during its rotary movement, is consecutively rotatable about at least two different axes of rotation.

THIS APPLICATION IS A CONTINUATION OF INTERNATIONAL APPLICATION PCT/EP 2003/009317 FILED AUG. 22, 2003, WHICH CLAIMS PRIORITY OF GERMAN PATENT APPLICATION S.N. 102 41 807.1, FILED SEP. 6, 2002.

### FIELD OF THE INVENTION

The invention relates to an electric power generator assembly. In particular, it is adapted for use with portable equipment such as portable computers (laptops), portable music playing devices or toys and is intended to replace conventional batteries or accumulators.

### BACKGROUND OF THE INVENTION

There are numerous known portable devices which are powered by batteries or accumulators independently of the mains. Examples are portable computers (laptops, notebooks), portable telephones, portable music playing devices or toys.

U.S. patent Application Publication U.S. 2002/007554 A1 describes a portable power generator assembly with an internal combustion engine, a fuel tank and an electric power generator. The internal combustion engine is a conventional reciprocating piston motor. Fuel tank, motor and generator are mounted side-by-side on a pase plate. This is a rather bulky structure, which is to serve as electric power source for camping purposes or the like.

WO 00/36337 discloses an electric torch with a fuel tank, an internal combustion engine and an electric power generator for energizing a lamp. The internal combustion engine, again, is a conventional reciprocating piston motor. The components are accommodated in compact arrangement in a rectangular housing.

U.S. patent application Ser. No. 10/773,039 filed Aug. 8, 2002 by Boris Schapiro et al. discloses a rotary piston engine, wherein the cross section of a prismatic chamber defined in a housing is tri-oval with first and second circular arcs of alternatingly a relatively small radius of curvature and a relatvely large radius of curvature, these arcs being joined continuously and differentiably. A rotary piston of bi-oval cross section is guided in the chamber. The bi-oval cross section of the rotary piston is formed by alternating first and second circular arcs having the smaller and the larger radii of curvature, respectively, of the tri-oval cross section of the chamber, the circular arcs, again, being joined continuously and differeantiably. The bi-oval rotary piston carries out cycles of motion, in the tri-oval chamber, with jumping instantaneous axes of rotation. The movement of the rotary piston is picked-off in a very simple way: A driving or driven shaft extends centrally through the tri-oval chamber, i.e. along the intersection of the axes of symmetry of the chamber. The driving or driven shaft carries a pinion. The rotary piston has an oval aperture with internal gear. The long axis of the cross section of the aperture extends along the short axis of the bi-oval cross section of the rotary piston. The pinion continuousy meshes with the internal gear.

A rotary piston engine of similar art design is disclosed in DE 199 20 289 C1.

### SUMMARY OF THE INVENTION

It is the object of the invention to provide a power supply assembly which is adapted for mobile use.

In particular, it is an object of the invention to provide an electric power generator assembly which can be used in conventional portable devices insead of a conventional battery or accumulator.

To this end, an electric power generator assembly comprises a rotary piston engine having a housing, which defines a prismatic chamber. The inner wall of this chamber has an oval contour. A rotary piston is rotatably guided in this chamber and has an oval contour. The contour of the chamber is defined by a first number of pairs of contiguous, alternating first and second circular arcs having different first and second radii of curvature, respectively. The contour of the rotary piston is defined by a second number of pairs of contiguous alternating first and second circular arcs having said first and second radii of curvature, said first and second numbers differing by one. Thereby variable volume working chambers are defined between the wall of said chamber and said rotary piston. The rotary piston, during its rotary movement, is consecutively rotatable about at least two different axes of rotation. Output shaft means are provided and means for transmitting the rotary movement of said rotary piston to said output shaft means. A fuel tank is attached to said rotary piston engine. There are means for supplying fuel from this fuel tank to the rotary piston engine and means for igniting said fuel within said working chambers of said rotary piston engine to drive said rotary piston. Power generator means are attached to the rotary piston engine and driven by said output shaft means for generating electric power. These power generator means and the rotary piston engine are combined to form a miniaturized unit the volume of which is substantially smaller than the volume of the fuel tank. Preferably fuel tank, said rotary piston engine and said electric power generator are arranged coaxially to form a compact unit.

Preferably, said oval contour of said chamber is tri-oval, defined by three pairs of first and second circular arcs, and said oval contour of said rotary piston is bi-oval defined by two pairs of first and second circular arcs, said bi-oval contour defining a longer axis of symmetry and a shorter axis of symmetry. Said movement transmitting means comprise an oval aperture through said rotary piston, said oval aperture defining a longer axis of symmetry and a shorter axis of symmetry, the longer axis of symmetry of said oval aperture extending in the direction of the shorter axis of symmetry of said bi-oval contour of said rotary piston. Said aperture has an internal gear. Said movement transmitting means further comprise a pinion on an output shaft, said pinion meshing with said internal gear of said oval aperture.

The fuel tank, the rotary piston engine and the electric power generator may be arranged coaxially to form a compact unit.

The invention is based on the discovery, that the rotary piston engines known from the U.S. patent application Ser. No. 10/773,093 or DE 199 20 289 can be substantially miniaturized and, nevertheless, form an appropriate power source.

Such a power generator unit can be used as power source for mobile power consumers. Such mobile power consumers are, for example, laptops, music playing devices, toys and the like, which require small power sources, as, otherwise, they are not portable. Because of the miniaturization, the power generator unit can fulfill the function of an accumulator or of conventional batteries. The unit need not be recharged at a power source but needs only be re-filled with fuel, which can also be transported independently of the electric mains. Furthermore, there is no disposal problem as with batteries or accumulators which also have a limited lifetime, even if they are re-chargeable. The time of operation of such a power generator unit is, by orders of magnitude, larger than the time of operation of a battery of comparable volume. Accordingly, the field of application is larger. In particular, the power generator unit is particularly advantageous at such locations, where electric power is not available or available only to a limited extent, as, for example, on expeditions, in vehicles or the like.

As the transport of electric power involves losses, the power generator unit can be used, particularly advantageously, also at those locations which are far away from an electric power source. There, they can replace the presently used solar cells.

Furthermore, the electric power genersator unit can be used as emergency power source, for example for alarm clocks or other clocks which have to be protected against power failure.

### BRIEF DESCRIPTION OF THE DRAWINGS

FIG. 1 shows an electric power generator assembly.

FIG. 2 is a cross sectional view of a rotary piston engine.

### DESCRIPTION OF EMBODIMENT

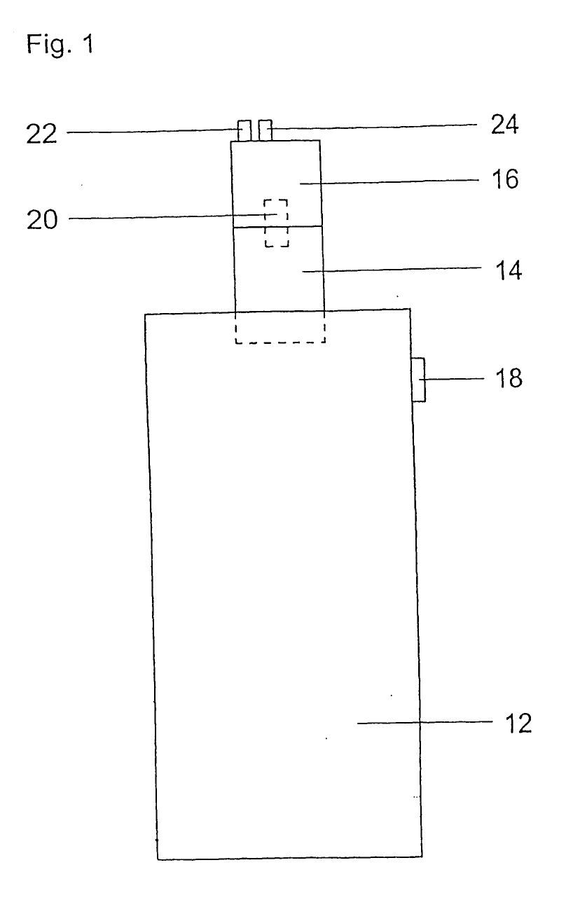

In FIG. 1, a power generator assembly 10 is shown. The power generator assembly 10 comprises a fuel tank 12, a rotary piston engine 14 and an electric power generator 16. The fuel tank 12 can be filled with fuel through an inlet 18. It may, however, also be replaced by a already filled fuel tank. To this end, the rotary piston engine 14 is removably attached to the fuel tank. The setup of the rotary piston engine 14 is identical with the engine described in U.S. patent application Ser. No. 10/773,093 filed Feb. 5, 2004 by Boris Schapiro et al., which patent application is hereby incorporated by reference. The rotary piston engine drives an output shaft 20. The generator 16 generates electrical power from the mechanical power of the output shaft, the power being available at two contacts 22 and 24.

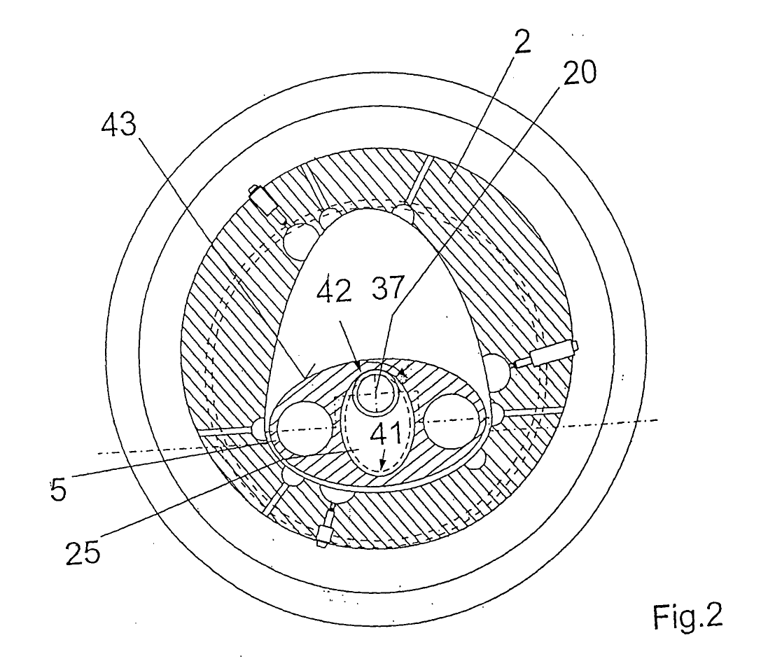

In FIG. 2, a cross sectional view of the rotary piston engine 14 is shown. The rotary piston 5 is of bi-oval shape, and the chamber in which the rotary piston moves is tri-oval. An oval is a non-analytical FIG. 43, which is composed exclusively of circular arcs. In one cycle, within which the rotary piston moves back to its original position again, the rotary piston rotates about three different axes, which pass through the centers of curvature of the “corners” of the tri-oval chamber. Transition from one axis of rotation to the next one takes place discontinuously. The rotation of the rotary piston is transmitted to the output shaft 20 through a longitudinal bore 25.

The electric power generator assembly may be arranged in a mast for street lamps. Then the outer dimensions of the fuel tank are substantially equal to the inner diameter of the mast. In the lamp part, the miniaturized rotary piston engine and generator unit is accommodated, which provides the electric power for the lamp.

The power generator assembly may also have the outer dimensions of a battery or of an accumulator. Then it can, if necessary with appropriate adsapters, replace such battery or accumulator in conventional electric consumers.

1. An electric power generator assembly comprising:
a rotary piston engine having a housing, which defines a prismatic chamber the inner wall of which having an oval contour, and a rotary piston rotatably guided in said chamber and having an oval contour, the contour of said chamber being defined by a first number of pairs of contiguous, alternating first and second circular arcs having different first and second radii of curvature, respectively, and the contour of said rotary piston being defined by a second number of pairs of contiguous alternating first and second circular arcs having said first and second radii of curvature, said first and second numbers differing by one, whereby variable volume working chambers are defined between said wall of said chamber and said rotary piston, and said rotary piston, during its rotary movement, is consecutively rotatable about at least two different axes of rotation,
output shaft means and means for transmitting the rotary movement of said rotary piston to said output shaft means,
a fuel tank attached to said rotary piston engine, means for supplying fuel from said fuel tank to said rotary piston engine and means for igniting said fuel within said working chambers of said rotary piston engine to drive said rotary piston, and
power generator means attached to said rotary piston engine and driven by said output shaft means for generating electric power,
said power generator means and said rotary piston engine being combined to form a miniaturized unit the volume of which is substantially smaller than the volume of the fuel tank.

2. An electric power generator assembly as claimed in claim 1, wherein said fuel tank, said rotary piston engine and said electric power generator are arranged coaxially to form a compact unit.

3. An electric power generator assembly as claimed in claim 1, wherein said oval contour of said chamber is tri-oval, defined by three pairs of first and second circular arcs, and said oval contour of said rotary piston is bi-oval defined by two pairs of first and second circular arcs.

4. An electric power generator assembly as claimed in claim 1, wherein
said oval contour of said chamber is tri-oval, defined by three pairs of first and second circular arcs, and said oval contour of said rotary piston is bi-oval defined by two pairs of first and second circular arcs, said bi-oval contour defining a longer axis of symmetry and a shorter axis of symmetry,
said movement transmitting means comprise an oval aperture through said rotary piston, said oval aperture defining a longer axis of symmetry and a shorter axis of symmetry, the longer axis of symmetry of said oval aperture extending in the direction of the shorter axis of symmetry of said bi-oval contour of said rotary piston, said aperture having an internal gear,
said movement transmitting means further comprise and a pinion on an output shaft, said pinion meshing with said internal gear of said oval aperture.

5. An electric power generator assembly as claimed in claim 1, wherein said fuel tank is re-fillable.

6. An electric power generator assembly as claimed in claim 1, and further comprising means for releasably attaching said fuel tank to said rotary piston engine, to permit interchanging of said fuel tank.
